(19) United States
(12) Patent Application Publication
(10) Pub. No.: US 2008/0259160 A1
(43) Pub. Date: Oct. 23, 2008

(54) VEHICLE VIDEO RECORDING DEVICE

(75) Inventors: Kazuya Morimitsu, Osaka (JP); Takayuki Mitsuo, Osaka (JP); Makoto Ubukata, Nara (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Osaka (JP)

(21) Appl. No.: 11/877,145

(22) Filed: Oct. 23, 2007

(30) Foreign Application Priority Data
Apr. 17, 2007 (JP) 2007-107936

(51) Int. Cl. H04N 9/47

(52) U.S. Cl. 348/148; 348/E07.001

(57) ABSTRACT

A vehicle video recording device includes surveillance cameras, an electronic memory for temporarily storing the videos shot by the cameras, a hard disk drive (HDD) for receiving and storing the video data from the electronic memory, a running environmental data memory for storing the running environmental data along a route, on which the vehicle runs, which data affects the recording performance of the HDD, and a recording controller for controlling transmission and recording of the video from the electronic memory to the HDD during a route section, where the recording performance of the HDD does not lower, based on the running environmental data. This structure allows saving the recording device from having sensors, and yet, the video recording device can positively records the video shot by the cameras even if vibration or impact happens.

### FIELD OF THE INVENTION

The present invention relates to a video recording device of a vehicle surveillance system of which surveillance cameras are installed in the vehicle and monitor an abnormality happening in the vehicle, and the video recording device records and stores the video shot by the cameras.

### BACKGROUND OF THE INVENTION

When an abnormality happens in a train, any one of passengers has pushes an emergency button to notify the train crew, such as a motorman or a conductor, of the abnormality. This is the most popular way to notify the train crew of an abnormality, and this method employs an extremely simple mechanism for the passengers and the crew to operate in a simple manner at an emergency. In general, a voice or a buzzer for paging is used, and for instance, a rail-car number from which an emergency notice is given is displayed on a monitor display coming with the voice, then an aural communication is done between the train crew and the passenger. If no response is obtainable from the train crew within a given period, some system automatically allows the passenger to communicate directly with the operating room through a train radio communication device.

Unexamined Japanese Patent Publication No. 2003-346261 discloses the train surveillance system including a video recording device. This system allows its cameras installed in respective rail-cars to shoot a video no later than an abnormality happens in one of the rail-cars, and the video is displayed on a display installed in a crew cabin on a real time basis as well as stored in a hard disk drive (HDD) of the video recording device. This video recording device temporarily stores videos, shot by the cameras while the train runs, in a memory device, and also stores them in the HDD at any time for storing purpose, so that videos for a long time can be recorded.

An example of the foregoing interior surveillance system is described hereinafter. FIG. 5 shows a block diagram schematically illustrating a conventional structure of interior surveillance system 50 for train such as a streetcar, railroad train, diesel train, and monorail car.

A passenger pushes any one of emergency buttons 62 of alarm slave-parts 57a-57c at an occurrence of abnormality in a rail-car interior of a train, then cameras 75a-75f installed in that rail-car shoot the abnormality and the videos are displayed on a monitor display together with the operating information such as an operation number, car number, point where the abnormality happens, station-to-station, date and time of the abnormality and so on. The operating information is transmitted via respective two-core shielded wires 74a-74f connecting the cameras to video controllers to the monitors of video transmitter 73a and 73b placed in the motorman's cab of the train. When a plurality of passengers give emergency notices, this interior surveillance system 50 allows video transmitters 73a, 73b to display the videos, shot by cameras 75a-75f installed at two spots in each one of the rail-cars, on their monitor displays in a double-page screen mode. The system still retains the data of the train where the abnormality has happened even if the car-number and station-to-station data supplied from train data setter 63 is deleted.

Even if a passenger gives an emergency notice to the crew or notices the crew of an abnormality of opening/closing the door, the crew (motorman or conductor) cannot immediately respond the notice depending on the operating situation. In such a case this system 50 allows automatic announcing apparatus 66 installed in the train to promptly give the passengers in the train an appropriate audible guide. When the train is operated by a motorman only and without a conductor, the motorman cannot immediately respond the notice if a passenger gives an emergency notice or informs the motorman of an abnormality of opening/closing the door during the operation. In such a case, after a given time based on the information about the train such as point information of the train and information about station-to-station and before the cars arrive at the next station, a train radio communication device installed at a particular place in the motorman's cab so as not to disturb the motorman allows the passenger to directly communicate with the operating room via audio and video. In this case, the monitor screens installed in the operating room and the motorman's cab can display the videos in a full screen, double-page screen, or quadruple-page screen manually selectable by the motorman or a staff in the operating room.

The foregoing interior surveillance system 50 also includes video recording device 69, which is specifically formed of a semiconductor-oriented electronic memory and an HDD having a mechanically movable section. The HDD is vulnerable to mechanical vibration; in particular, the HDD with a shorter access time and a higher capacity at a greater density is subject to external disturbance due to the vibration. For instance, when a magnetic head parking on a disk in the HDD receives an impact or vibrations during the operation of the train, a data access error or a malfunction tends to occur. To overcome this drawback, video recording device 69 of system 50 temporarily stores the input data in a first memory means (electronic memory) during the operation of the train, and transfers the data from the first memory means to the second memory means (HDD) for a storage purpose during the halt of the operation or the operation at a low speed where lower impact or less vibration is expected.

To be more specific, videos shot by each one of cameras 75a-75f installed in the train and the operating information about the train are recorded in the electronic memory while the train runs, and the videos and the information can be transferred and stored into the HDD when the train is stopped or run at a speed not higher than 5 km/hour as well as when the capacity of the electronic memory exceeds a predetermined level. System 50 includes emergency alarm master parts 51a, 51b and video controllers 71a-71c besides the elements discussed above.

The foregoing system, however, will transfer the data from the electronic memory to the HDD only when the train is stopped or runs at a speed not higher than 5 km/hour, so that an expensive semiconductor memory having a large capacity should be employed. On top of that, the video shot by the cameras cannot be recorded depending on an operating status.

Unexamined Japanese Patent Publication No. 2006-277812 discloses a train video recording device, which device improves the method of transferring data from the first memory means (electronic memory) to the second memory means (HDD) without using the expensive semiconductor memory having a large capacity.

FIG. 6 shows a block diagram schematically illustrating a conventional structure of the improved train video recording device. In FIG. 6, video recording device 80 comprises the following elements:
delay buffer memory 81 for storing input-data temporarily;
HDD 85 for storing the data transferred from buffer memory 81;
first vibration sensor 82 for detecting vibration greater than a given value and produced in a train and;
second vibration sensor 83; and
access control signal generator 84 for generating an access control signal that prohibits the data from being transferred from buffer memory 81 to HDD 85, when first vibration sensor 82 or second vibration sensor 83 detects the vibration and until the affect of the vibration spends itself.

Video recording device 80 shown in FIG. 6 allows both of first vibration sensor 82 placed near the axle shaft and second vibration sensor 83 mounted on a damper and placed near HDD 85 to detect vibration produced while the train is in motion. Device 80 prohibits a write operation onto HDD 85 in advance before HDD 85 per se is affected by vibration, and yet, it keeps prohibiting the write operation until second vibration sensor 83 detects that the vibration has spent itself. The data obtained during this prohibition is read from delay buffer memory 81 and is written into HDD 85 while HDD 85 is free from being affected by the vibration. Even if the train suddenly receives vibration, the foregoing structure allows steadily storing the data in HDD 85 free from errors in a writing operation or problems such as a malfunction of a magnetic head of HDD 85 while video recording device 85 continuously records a large amount of data transmitted from, e.g. a terrestrial digital broadcasting during the train in motion. While the train is in motion and no vibration happens, the data can be written into HDD 85, so that delay buffer memory 81 can work with a smaller capacity. As a result, the cost of the data-recording device can be lowered.

Video recording device 80 discussed above; however, needs an additional plurality of vibration sensors for detecting the vibration of a train, and if the vibration sensors do not work properly, or delay the timing of detecting the vibration, the input data cannot be recorded correctly in the HDD, or the HDD tends to malfunction.

### SUMMARY OF THE INVENTION

A vehicle video recording device of the present invention is used for recording videos shot in a vehicle running along a regular route. This video recording device comprises the following elements:
surveillance cameras for monitoring the interior of the vehicle;
an electronic memory for temporarily storing the video shot by the surveillance cameras;
a hard disk drive (HDD) for receiving video data from the electronic memory for storing;
a running environmental data memory for recording the running environmental data which affects the recording performance of the HDD; and
a recording controller for controlling the transfer of the video from the electronic memory to the HDD, based on the running environmental data, within a period within which the recording performance of the HDD is not lowered.

This structure needs no vibration sensors, and allows positively recording the video shot by the surveillance cameras although the vehicle encounters a vibration or an impact. When a vibration or an impact happens, the HDD is prohibited from being accessed, so that the number of malfunctions of the HDD decreases, thereby extending the life time of the HDD.

### BRIEF DESCRIPTION OF THE DRAWINGS

FIG. 1 shows a block diagram schematically illustrating a structure of a train video recording device in accordance with an embodiment of the present invention.

FIG. 2 illustrates a general route from a departure station to a terminal station, and an operating status of a train in which the train video recording device is mounted.

FIG. 3 shows a flowchart including the steps of recording the information of the video recording device in accordance with an embodiment of the present invention.

FIG. 4 illustrates a radio notifying system used in an emergency between the train in which the video recording device is mounted and the operation control center.

FIG. 5 shows a block diagram schematically illustrating a conventional structure of a train video recording device of a train interior surveillance system.

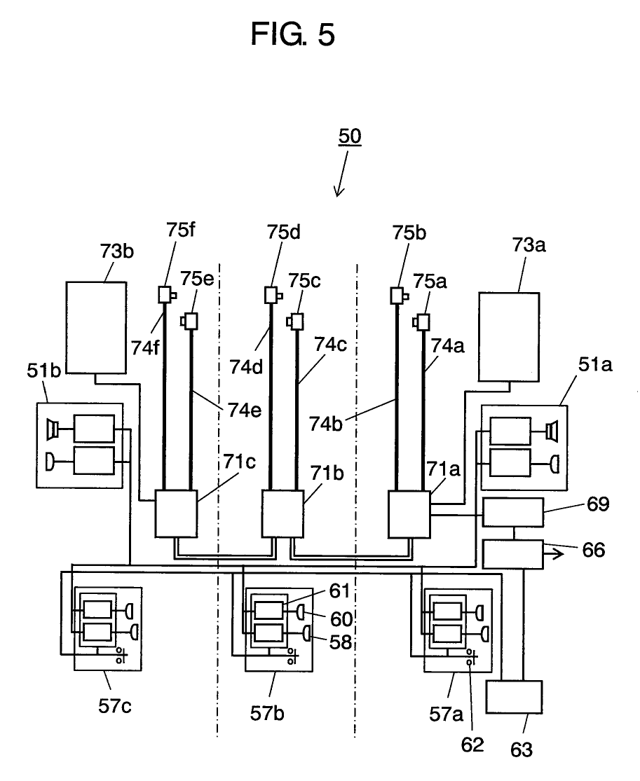

FIG. 6 shows a block diagram schematically illustrating a conventional structure of a train video recording device of which data transfer performance from an electronic memory to an HDD has been improved.

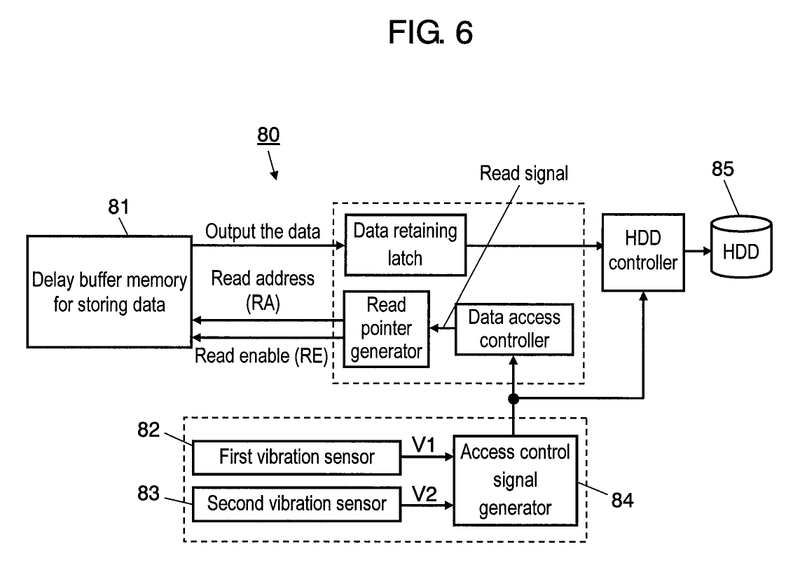

### DESCRIPTION OF PREFERRED EMBODIMENT

An exemplary embodiment of the present invention is described hereinafter with reference to the accompanying drawings. The vehicle video recording device of the present invention refers to a vehicle such as a railroad train, streetcar, diesel train, monorail car and automobile running along a fixed driving lane. However the present invention is described hereinafter by example of the railroad train.

### Exemplary Embodiment

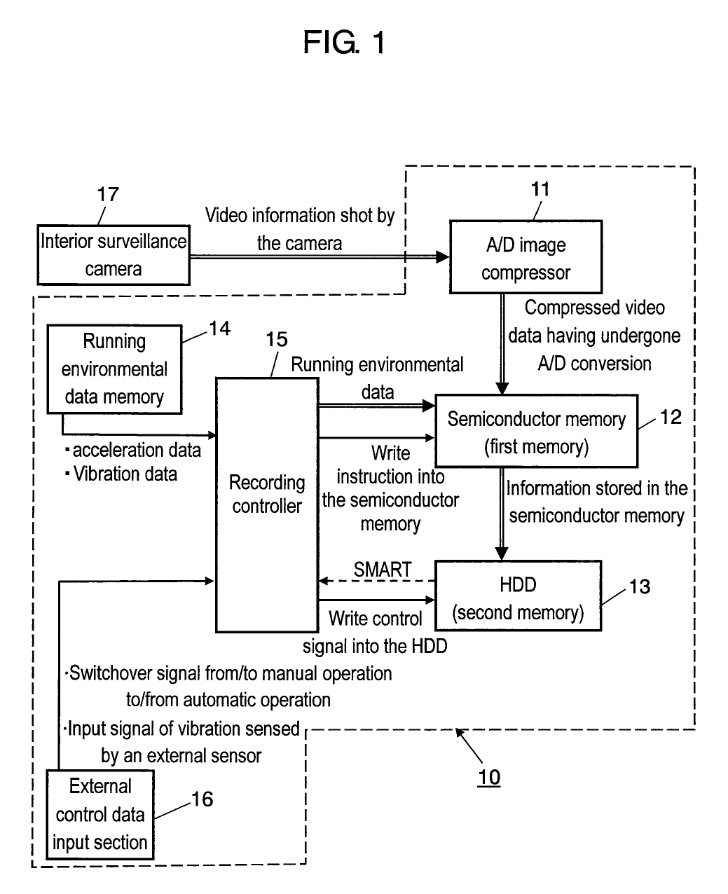

FIG. 1 shows a block diagram schematically illustrating a structure of a train video recording device in accordance with the embodiment of the present invention. As shown in FIG. 1, train video recording device 10 includes A/D image compressor 11, semiconductor memory 12 (first memory), HDD 13 (second memory), running environmental data memory 14, recording controller 15, and external control data input section 16 (control data formed outside of the device is input). A/D image compressor 11 is coupled with signal cables for transmitting video signals shot by surveillance camera 17. A/D Image compressor 11 receives an analog video signal shot by camera 17, and converts it into a digital signal before the digital signal undergoes the signal compression. The first memory, i.e. semiconductor memory 12, receives a write instruction signal from recording controller 15 at the same time when the train starts running, so that the digital video data, having undergone the A/D conversion and the image compression in A/D image compressor 11, is recorded in memory 12. The second memory, i.e. HDD 13, writes and records the video data stored in semiconductor memory 12 therein based on a write-control signal supplied from recording controller 15. This write-control signal is produced by using the running environmental data stored in data memory 14 and a data signal supplied from external control data input section 16.

HDD 13 transmits its SMART signal to recording controller 15, which then can control the write-operation of HDD 13 based on the SMART signal. HDD 13 can employ a removal hard disk. Running environmental data memory 14 stores various data of the route along which the train runs. The various data are transmitted to recording controller 15, and work as a basis for controlling the write operation of the information stored in semiconductor memory 12 into HDD 13. The running environmental data is transmitted to memory 12, and stored therein together with the image-compressed signal having undergone the A/D conversion. This data includes the data necessary for operating the train along the route, such as time data, car-positional data, positive and negative acceleration data accompanying the operation of the train such as in response to increasing a speed, applying the brakes and a position and a time at running on a curve. The environmental data can also include vibration and impact data along the entire route and in response to the foregoing time data and positional data.

Recording controller 15 is a CPU for controlling over train video recording device 10, and gives a write instruction to semiconductor memory 12 as well as controls a write operation into HDD 13. External control data input section 16 receives a control signal from an external device and puts it into the interior surveillance system (not shown) having the video recording device 10, and then transmits the signal, independent of the data stored in environmental data memory 14, to recording controller 15 for controlling a write operation into HDD 13. The control signal supplied from the external device includes a signal for switching the write operation from/to automatic one to/from manual one, a signal of vibration or impact detected by an external sensor (not shown) during the train in motion, and an emergency control signal about an accident, earthquake, or abnormal weather. In FIG. 1, a double solid line indicates a flow of information such as video signals, running environmental data, and a single solid line indicates a flow of control signals.

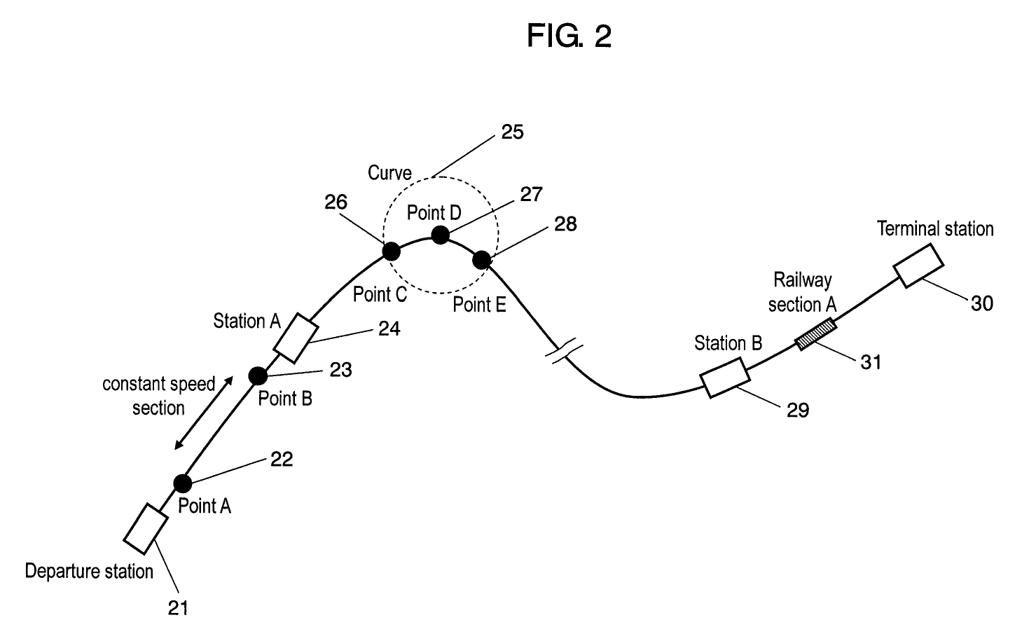

The running environmental data is specifically described hereinafter with reference to FIG. 2. FIG. 2 illustrates a general route from a departure station to a terminal station, and an operating status of a train in which the train video recording device is mounted. In FIG. 2, the train leaves departure station 21 and increases the speed until point A 22, then runs at a constant speed, and decelerates the speed by applying the brakes at point B 23 before station A 24 in order to prepare for stopping at station A 24. When positive or negative acceleration is applied to the train, the motion of a recording head of HDD 13 is affected, so that the recording operation becomes unstable. The train then leaves station A 24, and starts receiving outward acceleration due to centrifugal force at point C 26 before curve 25, and the centrifugal force becomes the maximum at point D 27, i.e. the maximum point of the curve (minimum curvature), then the centrifugal force spends itself at point E 28 where the train runs straight. In this case, HDD 13 becomes also unstable in recording operation. During railway section A 31 between station B 29 and terminal station 30, the train encounters up and down vibration depending on the rail condition. As discussed above, the data is prohibited from being transferred from electronic memory 12 to HDD 13 because HDD 13 becomes unstable in recording operation at the points where positive or negative acceleration is applied to the train, or at the point where the centrifugal force is applied to the train in running along a curve, or during a railway section where the train encounters the up and down vibration due to a poor rail condition. The data recording characteristics are greatly affected by the frequency, phase, and level of the vibration applied to the HDD. In general, the HDD is most susceptible to the vibration at a frequency lower than 60 Hz and a frequency resonant with the gimbal which supports the magnetic head to be used for recording/reproducing. The resonance frequency, in general, ranges from 700-800 Hz although the range depends on the type of HDD. Thus use of the running environmental data including the foregoing frequency, phase, and level of the vibration will allow controlling the recording operation more in detail. The data about the vibration and impact is recorded as the running environmental data, and the HDD can be determined whether or not they can record based on this environmental data, or whether the HDD can record or not is determined in advance, and only this determined information can be recorded.

Use of the time, a lapse of time or a distance covered from the departure station can identify the train position which adversely affects the recording operation. To be more specific, the train always runs along a regular route following the timetable. This is different from automobiles. Thus it is easy to identify the location of the train in motion. If a railroad schedule has gone haywire, and it is difficult to identify the location based on the timetable; however, use of a positioning system such as GPS allows easily identifying the present location of the train in motion.

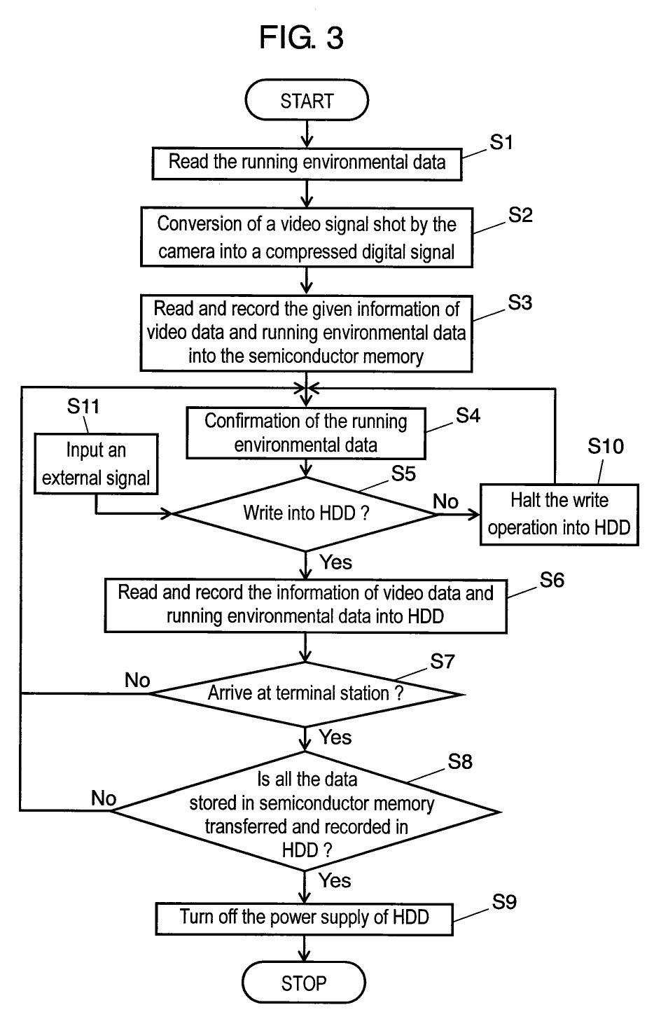

FIG. 3 shows a flowchart including the steps of recording the information of the video recording device in accordance with this embodiment of the present invention. The process of recording information into video recording device 10 is demonstrated hereinafter with reference to the flowchart shown in FIG. 3. When the train starts running, the process starts with reading the running environmental data stored in memory 14 into recording controller 15 (step S1). The running environmental data contains time-data, position-data, data of acceleration applied to HDD 13 when the train increases the speed, applies the brakes, and runs on a curve, data of ever changing vibration, and so on. Next, the analog video signal shot by camera 17 installed in the interior of the train is supplied to A/D image compressor 11, where the signal is converted into compressed digital video data (step S2). Then the compressed digital video data is written into the first memory, i.e. semiconductor memory 12, following a write-instruction signal supplied from recording controller 15. At this time, predetermined running environmental data stored in memory 14 is also written into the first memory (step S3).

Recording controller 15 then checks the running environmental data written in the first memory for confirming if any data affecting a write-operation into HDD 13 exists (step S4). The running environmental data checked and confirmed by controller 15 allows determining whether or not information data can be recorded in HDD 13 (step S5). It is determined YES, i.e. HDD 13 is ready to record, when the train is stopped, or the train runs at a constant speed, whereby acceleration or great vibration is not applied to HDD 13. On the other hand, it is determined NO, i.e. HDD is not ready to record, when the train is running and yet it increases the speed, or applies the brakes, or runs on a curve, whereby acceleration or vibration is applied to HDD 13.

Determination of “YES” in step S5 prompts controller 15 to send a write control signal to HDD 13, so that the video data stored in semiconductor memory 12, the running environmental data and so on are written and recorded into HDD 13 (step S6). Controller 15 then determines whether or not the train arrives at the terminal station based on the running environmental data read from running environmental data memory 14 (step S7). Determination of “NO” in step S7 prompts the step to return to step S4, and the steps of S4-S7 are repeated. Determination of “YES” in step S7 prompts controller 15 to check whether or not all the data stored in semiconductor memory 12 are recorded in HDD 13 (step S8). The check resulting in “NO” in step S8 prompts the step to return to step S4, and the steps of S4-S8 are repeated.

The check resulting in “YES” in step S8 prompts controller 15 to transmit a control signal to HDD 13 for turning off the power supply of HDD 13 (step S9) before the process of video recording device 10 is completed. Determination of “NO” in step S5 prompts controller 15 to transmit a control signal that prohibits HDD 13 from being written, so that the video data stored in memory 12 and the running environmental data are prohibited from being written into HDD 13 (step S10). Then the step is returned to step S4, and the foregoing steps are repeated.

Train video recording device 10 in accordance with this embodiment of the present invention includes external control data input section 16, which allows an interrupt handling in addition to the foregoing routine process. To be more specific, external control data input section 16 receives an external signal from an external device outside the interior surveillance system having video recording device 10, and transmits the external signal such as a switchover signal from/to automatic process to/from manual process, a signal about vibration sensed by an external sensor and so on to controller 15 (step S11). The foregoing external signal is independent of the data stored in running environmental data memory 14. Controller 15 then carries out the interrupt handling in step S5, so that the information stored in memory 12 is written into HDD 13.

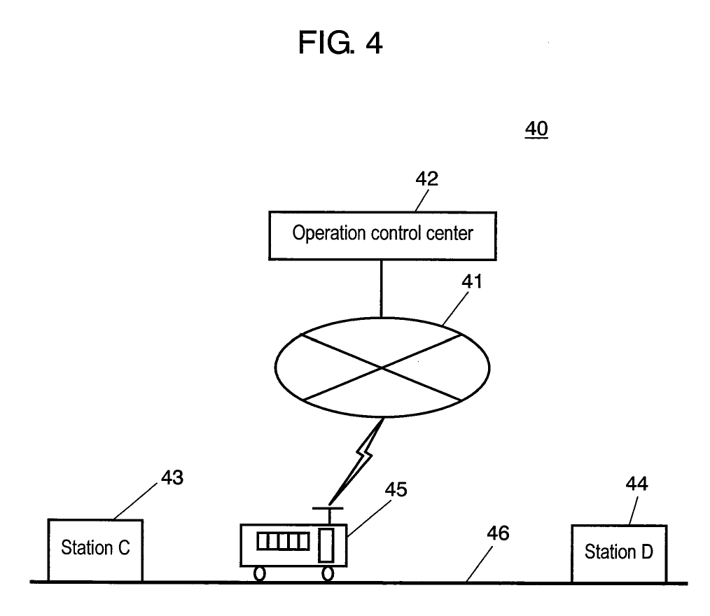

The external control data is not limited to the data sent from various devices mounted in the train, but it can be emergency information issued from the closest station or the operation control center where the operation of the trains is integrally administrated. Such a case is demonstrated hereinafter with reference to FIG. 4.

FIG. 4 illustrates radio notifying system 40 used in emergency between the train in which video recording device 10 in accordance with this embodiment is mounted and the operation control center. In FIG. 4, in the case of operation control center 42 notifying the train of emergency information when the train runs on rail 46 between station C 43 and station D 44, a control server (not shown) placed in center 42 distributes the notice through public radio communication network 41. Train 45 is equipped with a reception antenna (not shown) and a receiver (not shown), and the reception data is transmitted to external control data input section 16 shown in FIG. 1. Use of the radio communication function in the train as discussed above will allow receiving control data promptly from operation control center 42 when an emergency happens, and the control data allows controlling whether the video shot by the surveillance camera installed in the train can be recorded in HDD 13 or halted. The information only obtainable outside the train can thus control the write operation into HDD 13, so that the operation of HDD 13 can be controlled more in detail. In the case of controlling only with the data of vibration and impact, a shooting of a critical situation can be missed; however, the use of the external control data allows recording data appropriately without intermission, so that necessary videos can be always recorded.

The emergency information discussed above includes, e.g. prediction of vibration supposed to be applied to HDD 13 at when, where, and in which railway section when abnormal weather such as an earthquake, a typhoon, or an accident occurs around the destination of the train. These abnormal weather and accident are sometime so serious that the train must stop, or not so serious that the train can run with caution. When the train receives this emergency information, the recording operation into HDD 13 is halted upon necessary while the train runs in the particular railway section. The emergency information also includes the following cases: If a criminal gets on the train, and the police notifies the crew of this fact as an emergency, or the crew obtains the information that someone plants a bomb in the train, or an accident closes a tunnel, bridge, or rail. In such cases, vibration is supposed to be applied to HDD 13, so that the recording operation should be halted; however, since these cases are emergencies, the situation must be kept recording.

As discussed above, the train video recording device in accordance with this embodiment of the present invention records the video signal shot by the interior surveillance camera into the first memory, i.e. an electronic memory such as a semiconductor memory, and controls the write operation into the HDD based on the running environmental data about the entire route, which data has been stored in the running environmental data memory. The running environmental data contains the data necessary for operating the train along the route, such as time data, position data of the train, positive and negative acceleration data in response to the position and time of the train when the train increases speed, applies the brake, and runs on a curve. The running environmental data can include the data about vibration and impact of the entire route in response to the time data and position data of the train.

Use of the running environmental data in operating the train allows writing and recording the information data stored in the electronic memory into HDD 13 while the train runs at a constant speed so that no acceleration is applied to HDD 13 or no great vibration is applied to HDD 13. While acceleration, vibration or impact is supposed to be applied because the train increases speed, applies the brakes, or runs on a curve, HDD 13 is prohibited from writing the information data stored in the electronic memory.

In other words, the running environmental data along the entire route on which the train runs are measured and recorded in advance, and the write operation into the HDD is determined and controlled based on the running environmental data, so that the information can be recorded in the HDD intermittently when less vibration or impact is expected. The system includes the external control data input section which receives an external signal from an external device outside the interior surveillance system having the train video recording device, and transmits the external signal to controller 15 such as a switchover signal from/to automatic process to/from manual process, a signal about vibration or impact sensed by an external sensor, an emergency stop signal due to an accident, earthquake, abnormal weather, and other external signals of vibration or impact supposed to happen at the foregoing abnormality. The foregoing external signal is independent of the data stored in running environmental data memory 14. Thus the write operation into HDD 13 can be done as an interrupt handling.

The structure discussed above saves the train video recording device from having sensors, and allows the write operation into the HDD at a location where less vibration or impact can be expected, so that the video shot by the surveillance camera can be positively stored in the HDD. The structure also allows reducing the number of accesses to the HDD when vibration or impact happens, so that external damages can be suppressed and the life time of the HDD can be extended. On top of that, the operating time of the HDD can be eventually shortened, so that the write operation can be done efficiently. Those advantages can reduce the running cost of the video recording device, and decreases the number of errors in write/read operation, so that the reliability of the recording can be improved. The video recording device employing a simple system and method which do not need customarily monitoring the speed, vibration, and impact of the train is thus obtainable.

The train video recording device of the present invention refers to a train such as a streetcar, railroad train, diesel train, and monorail car; however, it is also applicable to an automobile running along a fixed driving lane.

In the foregoing embodiment, each rail-car is equipped with surveillance cameras, HDD, position sensor (e.g. GPS); however, the present invention is not limited to this instance. For example, a position sensor can be set at one place, e.g. at the leading rail-car, and the locations of each HDD placed in the respective rail-cars can be calculated from the output of this sensor. Because the train is formed of several rail-cars and intervals between them are kept constant while the train runs, this method can be employed.

In the foregoing embodiment, the running environmental data memory is formed of ROMs which are rigidly mounted near the controller; however, the present invention is not limited to this instance. For example, this memory can be formed of a removable medium such as flash memory card (e.g. SD card) or DVD. Use of the removal medium allows changing the running environmental data with ease.

What is claimed is:

1. A vehicle video recording device installed in the vehicle running along a regular route, which device comprising:
a surveillance camera for monitoring an interior of the vehicle;
an electronic memory for temporarily storing a video shot by the surveillance camera;
a hard disk drive (HDD) for recording video data sent from the electronic memory;
a running environmental data memory for storing running environmental data along the route, which data affects recording performance of the HDD; and
a recording controller for controlling such that the video can be transferred from the electronic memory to the HDD and recorded into the HDD during a route section, where the recording performance of the HDD does not lower, based on the running environmental data.

2. The vehicle video recording device of claim 1, wherein the running environmental data includes positive and negative acceleration data in response to a place or a time in increasing a speed, applying a brake, and running on a curve while the vehicle runs.

3. The vehicle video recording device of claim 1, wherein the running environmental data includes data at least one of vibration and impact of an entire route.

4. The vehicle video recording device of claim 1 further comprising an external control data input section, wherein the recording controller controls transfer and recording of the video from the electronic memory to the HDD based on a signal of switching a control of a write operation from/to manual operation to/from automatic operation, which signal is supplied from an external device through the external control data input section, or based on data of vibration or impact sensed by an external sensor and supplied through the external control data input section, while the vehicle runs along the route.

5. The vehicle video recording device of claim 3 or claim 4, wherein the data of vibration and impact contains information of a frequency, intensity, and phase of the vibration and the impact applied to the HDD.

6. The vehicle video recording device of claim 4 further comprising a communication means between the video recording device and an operation control center, wherein the vehicle receives emergency information from the operation control center while the vehicle runs along the route, and the recording controller transfers the video from the electronic memory to the HDD and records the video in the HDD based on the emergency information.

7. The vehicle video recording device of claim 6, wherein the emergency information refers to one of an accident, earthquake, abnormal weather, and a happening.
